(19) United States
(12) Patent Application Publication
(10) Pub. No.: US 2009/0069356 A1
(43) Pub. Date: Mar. 12, 2009

(54) USE OF ANILINOPYRIMIDINES IN WOOD PROTECTION

(76) Inventors: Dany Leopold Jozefien Bylemans, Hasselt (BE); Alex Raymond Albert Valcke, Dessel (BE)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/577,609

(22) PCT Filed: Oct. 20, 2005
(86) PCT No.: PCT/EP05/55431

§ 371 Date: Apr. 20, 2007

(30) Foreign Application Priority Data
Oct. 22, 2004 (EP) 04105244.0

(51) Int. Cl. A01N 43/54

(52) U.S. Cl. 514/275

(57) ABSTRACT

The present invention relates to the use of the anilinopyrimidines pyrimethanil, cyprodinil and mepanipyrim for the protection of wood and wood materials against wood destroying and wood discolouring fungi.

The present invention relates to the use of the anilinopyrimidines pyrimethanil, cyprodinil and mepanipyrim for the protection of wood and wood materials against wood destroying and wood discolouring fungi.

The anilinopyrimidines of formula (I) have the following general formula

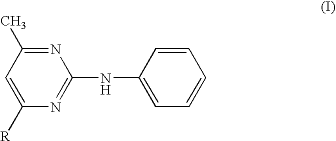

wherein R represents methyl, cyclopropyl or propyn-1-yl.

A first anilinopyrimidine of formula (I) is the compound of formula (I) wherein R represents methyl. Said compound is 4,6-dimethyl-N-phenyl-2-pyrimidinamine which is also known as “pyrimethanil”. Pyrimethanil was first described in DDR patent application DD-151,404 as compound (1) having fungicidal activity against phyto-phatogenic fungi. It has protective and curative fungicidal activity and is used to control grey mould on vines, fruit, vegetables and ornamentals.

A second anilinopyrimidine of formula (I) is the compound of formula (I) wherein R represents cyclopropyl. Said compound is 4-cyclopropyl-6-methyl-N-phenyl-2-pyrimidinamine which is also known as “cyprodinil”. Cyprodinil was first described in EP-0,310,550 as compound (1.1) having activity against phytopathogenic fungi.

A third anilinopyrimidine of formula (I) is the compound of formula (I) wherein R represents propyn-1-yl. Said compound is 4-methyl-6-(prop-1-ynyl)-N-phenyl-2-pyrimidinamine which is also known as “mepanipyrim”. Salt forms of mepanipyrim were first disclosed in EP-0,224,339 as compounds (41), (42) and (43) having fungicidal activity against phytopathogenic fungi.

U.S. Pat. No. 5,508,283 discloses mixtures containing anilinopyrimidines of formula (I) and α-(methoxyimino)-benzeneacetic acid ester derivatives in synergistic amounts. These synergistic mixtures are useful for combating phytopathogenic fungi.

Additionally their use in material protection (eg. wood protection) is mentioned but no data to support said use are provided. The active ingredients α-(methoxy-imino)-benzeneacetic acid ester derivatives and anilinopyrimidines of formula (I) however have to be applied simultaneously: jointly or separately or successively, wherein the sequence—in the case of separate application—has no effect on the result (see column 4, lines 14-17, of U.S. Pat. No. 5,508,283). Hence the fungicidal effect of the mixtures of U.S. Pat. No. 5,508,283 is always related to the combined use of the active ingredients.

U.S. Pat. No. 6,156,760 discloses fungicidal mixtures containing three active ingredients being an oxime, a carbamate and an anilinopyrimidine of formula (I) in synergistic amounts. These synergistic mixtures are useful for combating phytopathogenic fungi. Additionally their use in material protection (eg. wood protection) is mentioned but no data to support said use are provided. The active ingredients i.e. an oxime, a carbamate and an anilinopyrimidine of formula (I) however have to be applied simultaneously: together or separately or in succesion, wherein the sequence—in the case of separate application—has no effect on the result (see column 5, lines 31-34, of U.S. Pat. No. 6,156,760). Hence the fungicidal effect of the mixtures of U.S. Pat. No. 6,156,760 is always related to the combined use of the active ingredients.

Tjamos et al. describe in Journal of Phytopathology (2004), 152(4), 250-255, the effect of the fungicides carbendazim, Chorus® and Switch® to chemically control Aspergillus niger and A. carbonarius infection in vineyards. It was demonstrated that Switch® (combination of the fungicides fludioxonil and cyprodinil) was able to control Aspergillus spp. in contrast to carbendazim and Chorus® (cyprodinil as sole fungicidal ingredient) which were ineffective. It was concluded by Tjamos et al. that fludioxonil was responsible for the effectiveness of Switch®.

It has now been found that the anilinopyrimidines of formula (I) possess fungicidal activity against wood discolouring and wood destroying fungi when used as the sole fungicidal active ingredient.

The anilinopyrimidines of formula (I) may be present in their free base form or in the form of an inorganic acid addition salt which can be obtained by reaction of the free base form with an appropriate inorganic acid. Appropriate inorganic acids comprise, for example, the hydrohalic acids, i.e. hydrofluoric, hydrochloric, hydro-bromic and hydroiodic acid; sulfuric acid; nitric acid; phosphoric acid; phosphinic acid and the like.

The term “inorganic acid addition salt” as used hereinabove also comprises the solvates which the anilinopyrimidines of formula (I) are able to form. Examples of such solvates are e.g., the hydrates, alcoholates and the like.

The anilinopyrimidines of formula (I), and inorganic acid addition salts thereof, are useful for preventing, controlling or eliminating fungal growth on objects made of wood. The term “protection” as used throughout this text is meant to include the latter actions such as preventing, controlling or eliminating fungal growth. As used herein, “wood,” “wood material” and “wood products” shall mean all forms of wood, for example, solid wood (such as timber or lumber in the form of logs, beams, planks, sheets and boards), wood composite materials (such as wood fiber board, chip board and particle board) and all products made from wood and wood-composite materials (such as mill frames, decking, siding, siding cladding, roof shingles, utility poles, and railway sleepers).

Wood and wood materials which are to be protected or preserved from staining, discolouring and decay by wood-discolouring or wood-destroying fungi is meant to be protected from for example, moulding, rotting, loss of its useful mechanical properties such as breaking strength, resistance to shock and shearing strength, or decrease of its optical or other useful properties due to the occurrence of odour, staining and spot formation. These phenomena are caused by a number of wood-discolouring or wood-destroying fungi of which the following are typical examples:

### Wood-Discolouring Fungi:

1: Ascomycetes: Ceratocystis e.g. Ceratocystis minor.
Aureobasidium e.g. Aureobasidium pullulans
Sclerophoma e.g. Sclerophoma pithyophila
Cladosporium e.g. Cladosporium herbarum
   2: Deuteromycetes: Fungi imperfecti;
Aspergillus e.g. Aspergillus niger;
Dactylium e.g. Dactylium fusarioides;
Penicillium e.g. P. brevicaule, P. variabile, P. funiculosum or P. glaucum;
Scopularia e.g. Scopularia phycomyces; and
Trichoderma e.g. Trichoderma viride or Trichoderma lignorum.
   3: Zygomycetes: Mucor e.g. Mucor spinorus.

### Wood-Destroying Fungi

I: Soft-rot Fungi: Chaetomium e.g. Ch. globosum or Ch. alba-arenulum;
Humicola e.g. Humicola grisea;
Petriella e.g. Petriella setifera; and
Trichurus e.g. Trichurus spiralis.
   2: White and brown rot Fungi:
Coniophora e.g. Coniophora puteana;
Coriolus e.g. Coriolus versicolor;
Donkioporia e.g. Donkioporia expansa;
Glenospora e.g. Glenospora graphii;
Gloeophyllum e.g. Gl. abietinum, Gl. adoratum, Gl. protactum, Gl. sepiarium or Gl. trabeum;
Lentinus e.g. L. cyathiformes, L. edodes, L. lepideus, L. grinus or L. squarrolosus;
Paxillus e.g. Paxillus panuoides;
Pleurotus e.g. Pleurotis ostreatus;
Poria e.g. P. monticola, P. placenta, P. vaillantii or P. vaporaria;
Serpula (Merulius) e.g. Serpula himantoides or Serpula lacrymans;
Stereum e.g. Stereum hirsutum;
Trychophyton e.g. Trychophyton mentagrophytes; and
Tyromyces e.g. Tyromyces palusts.

The present invention also provides the use of fungicidal compositions comprising an anilinopyrimidine of formula (I), or an inorganic acid addition salt thereof, and one or more appropriate carriers, for the protection of wood and wood materials against wood destroying and wood discolouring fungi.

The amount of anilinopyrimidine of formula (I) in fungicidal compositions will be so that an effective fungicidal effect against wood-discolouring or wood-destroying fungi is obtained. In particular it is contemplated that ready-to-use fungicidal compositions of the present invention comprise an anilinopyrimidine of formula (I) in a range from 50 to 5000 ppm (w/v), in particular from 100 to 3000 ppm (w/v). In many instances the fungicidal compositions to be used directly, also known as ready-to-use compositions, can be obtained from concentrates, such as e.g. emulsifiable concentrates, suspension concentrates, or soluble concentrates, upon dilution with aqueous or organic media, such concentrates being intended to be covered by the term composition as used in the definitions of the present invention. Such concentrates can be diluted to a ready to use mixture in a tank shortly before use.

As mentioned above an emulsifiable concentrate is a liquid, homogeneous formulation comprising an anilinopyrimidine of formula (I) to be applied as an emulsion after dilution in water. A suspension concentrate is a stable suspension comprising an anilinopyrimidine of formula (I) in a fluid intended for dilution with water before use. A soluble concentrate is a liquid, homogeneous formulation to be applied as a true solution of the active ingredients after dilution in water.

The appropriate carriers for use in fungicidal compositions comprising an anilinopyrimidine of formula (I) are any material or substance with which said anilino-pyrimidines of formula (I) are formulated in order to facilitate their application to the wood or wood material to be treated and/or to facilitate the storage, transport or handling of the fungicidal compositions without impairing their antifungal effectiveness. Such appropriate carriers may be any liquid or solid and correspond to suitable substances known in the art of formulation.

Suitable solvents as a carrier are aromatic hydrocarbons, preferably the fractions containing 8 to 12 carbon atoms, e.g. dimethylbenzene mixtures or substituted naphthalenes, phthalates such as dibutyl phthalate or dioctyl phthalate, aliphatic or alicyclic hydrocarbons such as cyclohexane or paraffins, alcohols and glycols and their ethers and esters, such as ethanol, ethylene glycol, ethylene glycol monomethyl or monoethyl ether, ketones such as cyclohexanone, strongly polar solvents such as N-methyl-2-pyrrolidone, dimethylsulfoxide or dimethylformamide, as well as vegetable oils or epoxidised vegetable oils such as epoxidised coconut oil or soybean oil; or water.

Appropriate solid carriers used e.g. for dusts and dispersible powders are normally natural mineral fillers such as calcite, talcum, kaolin, montmorillonite or attapulgite. In order to improve the physical properties it is also possible to add highly dispersed silicic acid or highly dispersed absorbent polymers. Suitable granulated absorbent carriers are of the porous type, for example pumice, broken brick, sepiolite or bentonite; and suitable nonsorbent carriers are materials such as calcite or sand. In addition, a great number of pregranulated materials of inorganic or organic nature can be used, e.g. especially dolomite or pulverised plant residues.

The fungicidal compositions comprising an anilinopyrimidine of formula (I), or an inorganic acid addition salt thereof, and one or more appropriate carriers, for use in the protection of wood and wood materials against wood destroying and wood discolouring fungi may optionally comprise one or more adjuvants such as dispersants, surfactants, wetting agents, adhesives, thickeners, binders, fertilizers, anti-freeze agents, repellents, colour additives, corrosion inhibitors, water-repelling agents, siccatives, or UV-stabilizers.

Suitable surface-active compounds to be used in fungicidal compositions comprising an anilinopyrimidine of formula (I) are non-ionic, cationic and/or anionic surfactants having good emulsifying, dispersing and wetting properties. The term “surfactants” will also be understood as comprising mixtures of surfactants.

Suitable anionic surfactants can be both water-soluble soaps and water-soluble synthetic surface-active compounds.

Suitable soaps are the alkali metal salts, earth alkaline metal salts or unsubstituted or substituted ammonium salts of higher fatty acids (C₁₀-C₂₂) e.g. the sodium or potassium salts of oleic or stearic acid, or of natural fatty acid mixtures which can be obtained e.g. from coconut oil or tallow oil. In addition, there may also be mentioned fatty acid methyltaurin salts.

More frequently, however, so-called synthetic surfactants are used, especially fatty sulfonates, fatty sulfates, sulfonated benzimidazole derivatives or alkylarylsulfonates. The fatty sulfonates or sulfates are usually in the form of alkali metal salts, earth alkaline metal salts or unsubstituted or substituted ammonium salts and contain an alkyl radical having from 8 to 22 carbon atoms said alkyl also comprising radicals derived from acyl radicals, e.g. the sodium or calcium salt of lignosulfonic acid, of dodecylsulfate or of a mixture of fatty alcohol sulfates obtained from natural fatty acids. These compounds also comprise the salts of sulfuric acid esters and sulfonic acids of fatty alcohol/ethylene oxide adducts. The sulfonated benzimidazole derivatives preferably contain 2 sulfonic acid groups and one fatty acid radical containing 8 to 22 carbon atoms. Examples of alkylarylsulfonates are the sodium, calcium or triethanolamine salts of dodecylbenzene sulfonic acid, dibutylnaphthalene-sulfonic acid, or of a naphthalene-sulfonic acid/formaldehyde condensation product. Also suitable are corresponding phosphates, e.g. salts of the phosphoric acid ester of an adduct of p-nonylphenol with 4 to 14 moles of ethylene oxide, or phospholipids.

Non-ionic surfactants are preferably polyglycol ether derivatives of aliphatic or cycloaliphatic alcohols, or saturated or unsaturated fatty acids and alkylphenols, said derivatives containing 3 to 10 glycol ether groups and 8 to 20 carbon atoms in the (aliphatic) hydrocarbon moiety and 6 to 18 carbon atoms in the alkyl moiety of the alkylphenols.

Further suitable non-ionic surfactants are the water-soluble adducts of polyethylene oxide with polypropylene glycol, ethylenediaminopoly-propylene glycol containing 1 to 10 carbon atoms in the alkyl chain, which adducts contain 20 to 250 ethylene glycol ether groups and 10 to 100 propylene glycol ether groups. These compounds usually contain 1 to 5 ethylene glycol units per propylene glycol unit.

Representative examples of non-ionic surfactants are nonylphenolpolyethoxy ethanols, castor oil polyglycol ethers, polypropylene/polyethylene oxide adducts, tributylphenoxypolyethoxyethanol, polyethylene glycol and octylphenoxypolyethoxy-ethanol. Fatty acid esters of polyethylene sorbitan, such as polyoxyethylene sorbitan trioleate, are also suitable non-ionic surfactants.

The fungicidal compositions comprising an anilinopyrimidine of formula (I), or an inorganic acid addition salt thereof, and one or more appropriate carriers, for use in the protection of wood and wood materials against wood destroying and wood discolouring fungi can comprise the anilinopyrimidines of formula (I) as the sole fungicidal active ingredient. However these fungicidal compositions may optionally comprise one or more additional active ingredients, such as fungicides, bactericides, acaricides, nematocides, or insecticides, in particular fungicides or insecticides, for example so as to widen the spectrum of action or to prevent the buildup of resistance.

As other active ingredients, which may be used in combination with the anilinopyrimidines of the present invention there may be considered products of the following classes:

Fungicides

2-aminobutane, 2,6-di-chloro-N-(4-trifluoromethylbenzyl)benzamide, 8-hydroxy-quinoline sulphate, 2-phenyl-phenol (OPP), aldimorph, ampropylfos, anilazine, benalaxyl, benodanil, benomyl, binapacryl, biphenyl, bitertanol, blasticidin-S, bupirimate, buthiobate, calcium polysulphide, captafol, captan, carbendazim, carboxin, quinomethionate, chloroneb, chloropicrin, chlorothalonil, chlozolinate, cufraneb, cymoxanil, cyprofuram, dichlorophen, diclobutrazol, diclofluanid, diclomezin, dicloran, diethofencarb, dimethirimol, dimethomorph, dinocap, diphenylamine, dipyrithion, ditalimfos, dithianon, dodine, drazoxolon, edifenphos, ethirimol, fenarimol, fenfuram, fenitropan, fenpiclonil, fenpropidin, fenpropimorph, fentin acetate, fentin hydroxide, ferbam, ferimzone, fluazinam, fludioxonil, fluoromide, flusulfamide, flutolanil, flutriafol, folpet, fosetyl-aluminium, fthalide, furalaxyl, furmecyclox, guazatine, hexachlorobenzene, hymexazol, imazalil, iminoctadine, iprobenfos (IBP), iprodione, isoprothiolane, kasugamycin, copper preparations such as: copper hydroxide, copper naphthenate, copper oxychloride, copper sulphate, copper oxide, oxine-copper and Bordeaux mixture, mancopper, mancozeb, maneb, mefenoxam, mepronil, metalaxyl, methasulfocarb, methfuroxam, metiram, metsulfovax, myclobutanil, nickel dimethyl-dithiocarbamate, nitrothal-isopropyl, nuarimol, ofurace, oxadixyl, oxamocarb, oxycarboxin, pefurazoate, pencycuron, phosdiphen, pimaricin, piperalin, polyoxin, prochloraz, procymidone, propamocarb, propineb, pyrazophos, pyrifenox, pyroquilon, pentachloronitrobenzene (PCNB), sulphur and sulphur preparations, tecloftalam, tecnazene, thiabendazole, thicyofen, thiophanate-methyl, thiram, tolclophos-methyl, tolylfluanid, triadimefon, triadimenol, triazoxide, trichlamide, tridemorph, triflumizole, triforine, validamycin A, vinclozolin, zineb, ziram; isothia- and benzisothiazolone derivatives such as, e.g. 1,2-benzisothiazolone (BIT); oxathiazines such as bethoxazin (i.e. 3-(benzo[b]thien-2-yl)-5,6-dihydro-1,4,2-oxathiazine, 4-oxide); strobilurines such as azoxystrobin, dimoxystrobin, fluoxastrobin, metominostrobin, pyraclostrobin, kresoxim-methyl, trifloxystrobin, and picoxystrobin; triazoles such as azaconazole, bromuconazole, cyproconazole, difenoconazole, dinicolazole, epoxiconazole, fenbuconazole, fluquinconazole, flusilazole, hexaconazole, ketoconazole, metconazole, penconazole, propiconazole, prothioconazole, simeconazole, tebuconazole, tetraconazole, and triticonazole.

Bactericides:

bronopol, dichlorophen, nitrapyrin, nickel dimethyldithiocarbamate, kasugamycin, octhilinone, furanecarboxylic acid, oxytetracyclin, streptomycin, tecloftalam, copper sulphate and other copper preparations.

Insecticides/Acaricides/Nematicides

abamectin, acephate, acetamiprid, acrinathrin, alanycarb, aldicarb, alphamethrin, amitraz, AZ 60541, azadirachtin, azinphos A, azinphos M, azocyclotin, Bacillus thuringiensis, bendiocarb, benfuracarb, bensultap, beta-cyfluthrin, bifenthrin, BPMC, brofenprox, bromophos A, bufencarb, buprofezin, butocarboxin, butylpyridaben, cadusafos, carbaryl, carbofuran, carbophenothion, carbosulfan, cartap, CGA 157 419, chloethocarb, chlorethoxyfos chlorfenvinphos, chlorfluazuron, chliormephos, chlorfenapyr, chlorpyrifos, chlorpyrifos M, cis-resmethrin, clocythrin, clofentezine, cyanophos, cycloprothrin, cyfluthrin, cyhalothrin, cyhexatin, cypermethrin, cyromazine, deltamethrin, demeton-M, demeton-S, demeton-5-methyl, diafenthiuron, diazinon, dichlofenthion, dichlorvos, dicliphos, dicrotophos, diethion, diflubenzuron, dimethoate, dimethylvinphos, dioxathion, disulfoton, edifenphos, emamectin optionally as its benzoate salt, esfenvalerate, ethiofencarb, ethion, ethiprole, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazinam, flucycloxuron, flucythrinate, flufenoxuron, flufenprox, fluvalinate, fonophos, formothion, fosthiazate, fubfenprox, furathiocarb, gamma-cyhalothrin, HCH, heptenophos, hexaflumuron, hexythiazox, imidacloprid, iprobenfos, isazophos, isofenphos, isoprocarb, isoxathion, ivemectin, lambda-cyhalothrin, lindane, lufenuron, malathion, mecarbam, mervinphos, mesulfenphos, metaldehyde, methacrifos, methamidophos, methidathion, methiocarb, methomyl, metolcarb, milbemectin, monocrotophos, moxidectin, naled, NC 184, nitenpyram, omethoate, oxamyl, oxydemethon M, oxydeprofos, parathion A, parathion M, permethrin, phenthoate, phorate, phosalone, phosmet, phosphamdon, phoxim, pirimicarb, pirimiphos M, pirimiphos A, profenofos, promecarb, propaphos, propoxur, prothiofos, prothoate, pymetrozin, pyrachlophos, pyridaphenthion, pyresmethrin, pyrethrum, pyridaben, pyrimidifen, pyriproxifen, quinalphos, salithion, sebufos, silafluofen, sulfotep, sulprofos, tebufenozid, tebufenpyrad, tebupirimiphos, teflubenzuron, tefluthrin, temephos, terbam, terbufos, tetrachlorvinphos, thiafenox, thiamethoxam, thiodicarb, thiofanox, thiomethon, thionazin, thuringiensin, tralomethrin, triarathen, triazophos, triazuron, trichlorfon, triflumuron, trimethacarb, vamidothion, XMC, xylylcarb, zetamethrin.

In order to protect wood or wood products against wood destroying or wood discolouring fungi said wood or wood products are treated with a fungicidal composition comprising an anilinopyrimidine of formula (I). Such treatment is applied by several different procedures such as, for example, by treating the wood in closed pressure or vacuum systems, in thermal or dip systems and the like, or by a wide variety of surface treatments, e.g. by spraying, atomizing, dusting, scattering, painting, pouring, brushing, dipping, soaking or impregnating the wood or wood product with a composition or emulsion comprising an anilinopyrimidine of formula (I).

### EXPERIMENTAL PART

### Experiment 1

### Poison Plate Assay

Activity against fungal growth was determined with the poison plate assay. A calculated amount of a stock solution (containing either pyrimethanil, cyprodinil or mepanipyrim in a concentration of 4000 ppm in dimethyl sulfoxide) was pipetted into multiwell plates in order to reach a final test concentration ranging from 0.6 to 20 ppm and mixed with a warm culture medium. These culture media were either Glucose Agar or GA (10 g glucose, 1.5 g K₂HPO₄, 2 g KH₂PO₄, 1 g (NH₄)₂SO₄, 0.5 g MgSO₄ and 12.5 g agar in 1 liter deionised water); Gelatin Glucose Agar or GGA (4 g gelatin, 4 g glucose, 1.75 g KH₂PO₄, 0.75 g MgSO₄ and 10 g agar in 11 deionised water); or Czapek-Dox Agar or CDA (30 g saccharose, 3 g NaNO₃, 1 g K₂HPO₄, 0.5 g MgSO₄.7H₂O, 0.5 g KCl, 0.01 g FeSO₄.7H₂O and 15 g agar in 11 deionised water). The medium was inoculated with 2 μl of a spore/mycelium suspension. The 24-multi-well plates were kept in the dark at a temperature of 22° C., and a relative humidity of 75% and evaluated for fungal growth after one week.

The following fungi species were used in the poison plate assay: Aureobasidium pullulans P 268 (Ap1); Aspergillus niger CBS 554.65 (An); Chaetomium globosum CEB 1218.2 (Cg); and Humicola grisea MG 28 (Hg).

The lowest concentration of each test compound or mixture of test compounds sufficient to inhibit visible growth was taken as the minimum inhibitory concentration (MIC). When no fungal growth was observed, the abbreviation “ng” was used in Table 1.

TABLE 1
MIC value in ppm of cyprodinil, pyrimethanil and mepanipyrim
against four wood degrading fungi in three different media.

| Test compound | Medium | Ap1 | An | Cg | Hg |
|---|---|---|---|---|---|
| cyprodinil | GA | 10 | <0.6 | ng | 10 |
| | GGA | 5 | <0.6 | ng | 20 |
| | CDA | 5 | <0.6 | ng | 10 |
| pyrimethanil | GA | 20 | <0.6 | ng | >20 |
| | GGA | 20 | 20 | ng | >20 |
| | CDA | 20 | <0.6 | ng | >20 |
| mepanipyrim | GA | 20 | <0.6 | ng | 20 |
| | GGA | 20 | <0.6 | ng | 20 |
| | CDA | 10 | <0.6 | ng | 10 |

### Experiment 2

### Stick Assay

| Test model: | Stick test | |
|---|---|---|
| Solvent: | ethanol | |
| Species of wood: | Scots Pine (Pinus sylvestris); 526 kg/m³ | |
| Wood dimensions: | 24 × 12 × 2 mm | |
| Treatment: | 250 μl/stick | |
| Drying: | overnight in sterile laminar flow cabinet | |
| Sterilization: | none | |
| Species of the fungi: | Basidiomycetes: | |
| | 1. Coriolus versicolor | CTB 863A |
| | 2. Coniophora puteana | BAM 15 |
| | Blue stain fungi: | |
| | 3. Aureobasidium pullulans | P 268 |
| | 4. Cladosporium cladosporioides | IHEM 3795 |
| | Moulds: | |
| | 5. Aspergillus niger | CBS 554.65 |
| | 6. Trichoderma viride | CBS 189.79 |
| | 7. Trichoderma sp. | isol. MB test |
| | Soft rot fungi: | |
| | 8. Chaetomium globosum | ATCC 6205 |
| | 9. Humicola grisea | MG 28 |

| | |
|---|---|
| Concentrations test | 50 - 100 - 200 - 400 - 800 - 1600 - 3200 - 6400 ppm |
| solutions: | |
| Inoculum: | Basidiomycetes (fungi 1-2) with a piece of agar (4 mm²) |
| | from the margin of an actively growing colony. All other |
| | fungi with 15 μl of a spore/mycelium suspension |
| Culture medium: | Potato Dextrose Agar (PDA): 4 g potato infusion, 20 g |
| | bacto dextrose and 15 g bacto agar in 1 liter deionised |
| | water |
| | Glucose Agar (GA): 10 g glucose, 1.5 g K₂HPO₄, 2 g |
| | KH₂PO₄, 1 g (NH₄)₂SO₄, 0.5 g MgSO₄ and 12.5 g agar in |
| | 1 liter deionised water |
| Culture conditions: | 22° C. and 70% relative humidity |
| Exposure period: | 3 weeks exposure |
| Validation: | Complete coverage of the control samples by all fungi. |
| Test model: | In each Petri-dish (diameter 5 cm) one treated test species was placed |
| | on the culture medium previously inoculated. The inoculum was situated |
| | at 2 places aside the stick and one on top of it. After the incubation |
| | period, surface score was evaluated using the following score system: |
| | 0: sticks free of fungal growth |
| | 1: traces of growth on the stick |
| | 2: slight growth (5 to 25% of the surface covered) |
| | 3: moderate growth (25 to 50% covered) |
| | 4: vigorous to maximum growth (more than 50%) |
| | The threshold value in this experiment is defined between the |
| | concentration with score ≦1 and the concentration with a score >1. |

The threshold value in the experiment is defined as the concentration range between the highest concentration with a score >1 and the lowest concentration with score <1. GA medium was used as a less nutrient-rich alternative to PDA, in order to prevent the test fungi from bypassing the specific mode of action of anilinopyrimidines like cyprodinil, pyrimethanil and mepanipyrim.

TABLE 2
Threshold values in ppm of three anilinopyrimidine compounds
in a stick test on two different culture media.

| | Compound: | | | | | |
|---|---|---|---|---|---|---|
| | pyrimethanil | | cyprodinil | | mepanipyrim | |
| | Medium: | | | | | |
| | PDA | GA | PDA | GA | PDA | GA |
| C. versicolor | >6400 | >6400 | >6400 | >6400 | >6400 | >6400 |
| C. puteana | >6400 | >6400 | >6400 | 3200-6400 | >6400 | >6400 |
| A. pullulans | >6400 | 1600-3200 | >6400 | 3200-6400 | >6400 | >6400 |
| C. cladosporioides | >6400 | 1600-3200 | >6400 | 800-1600 | >6400 | >6400 |
| A. niger | >6400 | >6400 | >6400 | >6400 | 1600-3200 | >6400 |
| T. viride | >6400 | >6400 | >6400 | >6400 | >6400 | >6400 |
| T. sp. | >6400 | >6400 | >6400 | >6400 | >6400 | >6400 |
| C. globosum | >6400 | 800-1600 | 1600-3200 | 100-200 | >6400 | 200-400 |
| H. grisea | 1600-3200 | 800-1600 | 800-1600 | 200-400 | >6400 | 200-400 |

1. A method of protecting wood and wood materials against wood destroying or wood discolouring fungi comprising applying an anilinopyrimidine of formula (I) 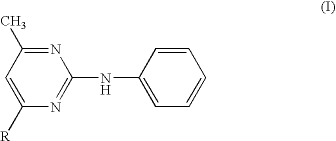
wherein R represents methyl, cyclopropyl or propyn-1-yl, or an inorganic acid addition salt thereof.

2. The method according to claim 1 wherein the anilinopyrimidine of formula (I) is pyrimethanil.

3. The method according to claim 1 wherein the anilinopyrimidine of formula (I) is cyprodinil.

4. The method according to claim 1 wherein the anilinopyrimidine of formula (I) is mepanipyrim.

5. A method of protecting wood and wood materials against wood destroying or wood discolouring fungi comprising applying a fungicidal composition comprising as the sole fungicidal active ingredient an anilinopyrimidine of formula (I) 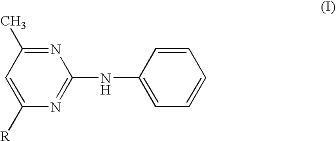
wherein R represents methyl, cyclopropyl or propyn-1-yl, or an inorganic acid addition salt thereof, and one or more carriers.

6. The method as claimed in claim 5 wherein the anilinopyrimidine of formula (I) is cyprodinil.

7. The method as claimed in claim 5 wherein the anilinopyrimidine of formula (I) is pyrimethanil.

8. The method as claimed in claim 5 wherein the anilinopyrimidine of formula (I) is mepanipyrim.

9. The method as claimed in claim 5 wherein the fungicidal composition further comprises one or more additional active ingredients selected from the group consisting of bactericides, acaricides, nematocides, and insecticides, or mixtures thereof.

10. The method of protecting wood or wood products against wood destroying or wood discolouring fungi wherein said wood or wood products are treated with a fungicidal composition comprising an anilinopyridimine of formula (I) as defined in claim 1, or an inorganic acid addition salt thereof, and one or more carriers.
